(19) United States
(12) Patent Application Publication
(10) Pub. No.: US 2014/0370838 A1
(43) Pub. Date: Dec. 18, 2014

(54) SYSTEM AND METHOD FOR PREVENTING ABUSE OF EMERGENCY CALLS PLACED USING SMARTPHONE

(71) Applicant: Han Seok KIM, Seoul (KR)

(72) Inventors: Han Seok Kim, Seoul (KR); Seong Soo Kim, Seoul (KR)

(73) Assignee: Han Seok KIM, Seoul (KR)

(21) Appl. No.: 14/375,026

(22) PCT Filed: Jan. 25, 2013
(86) PCT No.: PCT/KR2013/000614

§ 371 Date: Jul. 28, 2014

(30) Foreign Application Priority Data
Jan. 26, 2012 (KR) 10-2012-0007873

(51) Int. Cl. H04W 4/22; H04W 12/06

(52) U.S. Cl. CPC H04W 4/22; H04W 12/06; H04W 4/24
USPC 455/404.1

(57) ABSTRACT

The present invention relates to a system and method for preventing the abuse of emergency calls placed using a smartphone. When emergency information is transmitted to a preset guardian terminal by pressing a plurality of emergency buttons, a guardian terminal verifies whether or not there is an emergency and transmits an emergency situation experienced by a smartphone user to a server of an organization, and an officer from the organization having the server is sent to the coordinates of the location of the smartphone user which were received from the mobile communication service provider, thus enabling an organization such as a police department or a fire department to react to an emergency in the shortest possible amount of time when the smartphone user experiences said emergency. An Internet bank account of the smartphone user is converted to a preset virtual Internet bank account so as to be provided with a virtual Internet banking procedure. A bank account connected to a debit card or check card corresponding to a smartphone identification number is converted to a preset virtual bank account so as to enable an offline banking service, thus preventing additional damage to the smartphone user as a result of a cash withdrawal using the smartphone. The credit card information of the smartphone user is registered as information on a lost card, thus preventing additional damage to the smartphone user resulting from a payment by a credit card or from a card loan being taken out.

### TECHNICAL FIELD

The present invention relates, in general, to a system and method for preventing the abuse of an emergency call using a smartphone and, more particularly, to technology for, when a smartphone user transmits emergency information through the pressing of a plurality of emergency buttons upon the occurrence of an emergency situation, authenticating whether an emergency situation has occurred via a preset guardian terminal, transmitting the results of the authentication to the organization server, converting the Internet banking account of the smartphone user into a preset virtual Internet banking account, and providing a virtual Internet banking service.

### BACKGROUND ART

With a recent explosive increase in the number of mobile communication subscribers, mobile communication terminals have been recognized as necessities that can be frequently observed in surroundings recently. Mobile communication terminal manufacturers have commercialized multi-functional mobile communication terminals having high performance. To keep pace with this, communication service providers have provided high-level communication services and various additional services.

Like this, with regard to recently commercialized communication services, a technology for determining the location of a user through the tracing of a call from a mobile communication terminal has been developed. In line with this, mobile communication terminals and mobile communication services having a rescue request function in which, when a user is in an emergency situation, information about the emergency situation is automatically transmitted via a mobile communication terminal carried by the user and thus rescue is requested from an emergency rescue center or a law enforcement organization, such as a police department, have been commercialized.

However, as this technology is disclosed to the public, a problem arises in that in an actual situation, a criminal deprives a user of his or her terminal and then breaks the terminal before or after the user transmits an emergency signal, and thus a rescue signal is no longer generated. Furthermore, problems arise in that a location cannot be accurately traced even when a police officer has actually recognized the emergency situation of the user and in that a rescuer arrives at a site after the situation has been terminated even when the location can be accurately traced.

In order to provide for situations, such as the above cases, an emergency call processing method is used in which, when a mobile communication subscriber cannot directly make a voice call, notification of the site situation of an incident is provided by transmitting emergency information to an emergency contact point only through the manipulation of a button. However, a problem frequently occurs in that emergency situation information is unintentionally and erroneously transferred by the erroneous manipulation of the mobile communication terminal in an unwanted situation.

Furthermore, if the case occurs where an emergency response person does not recognize an emergency signal transmitted by a mobile communication subscriber when the mobile communication subscriber is in an emergency situation, a problem arises in that the reliability of the service is deteriorated because help cannot be provided to a user who wants rescue.

In order to overcome the above problems, the related industry has carried out various types of research and development. Korean Patent No. 10-0827709 (entitled “System and Method for Preventing Abuse of Emergency Call using Mobile Communication Network”) and a plurality of documents have been disclosed.

The above-described preceding patent is described with reference to FIG. 1 below. This technology includes a rescue requester terminal configured such that an emergency rescue key for an emergency situation of a user is formed thereon; a communication service provider server configured to receive emergency situation information from a rescue requester terminal and establish a connection between the rescue requester terminal and a rescuer terminal, and to, when emergency situation information is transferred from the rescuer terminal and a security server, perform switching to a call between the rescue requester terminal and the security server and transmit the telephone number of the rescue requester and information in the form of a short message to the rescuer terminal; the rescuer terminal configured to receive the rescue requester telephone number of the rescue requester terminal and the short message information input via the communication service provider server, and to provide notification of an emergency situation; and the security server configured to establish a connection to a secondary emergency contact point (a police department or a fire department) via the communication service provider server in the state of being capable of unidirectional reception from the rescue requester terminal and thus enable a call with the rescue requester terminal.

However, a problem arises in that secondary damage cannot be prevented, as in the case where, in case of emergency, although a secondary emergency contact point is notified of an emergency situation through the authentication of the preset guardian, a criminal connects to the Internet banking service of the rescue requester terminal and then transfers savings deposited in a user account to an account of a third party, or withdraws cash via a CD/ATM machine of a neighboring bank, before a police officer arrives at a the site of the emergency situation.

Furthermore, it is impossible in practice to report an emergency situation of the smartphone user over a phone by executing a 112 app installed on the smartphone or pressing a shortcut key. When emergency information is transmitted by pressing a single emergency button provided in the smartphone, a problem arises in that the transmission of emergency information is abused due to the carelessness of a user, with the result that a disadvantage arises in that the misuse of government services, such as the dispatch of a police officer, occurs.

Moreover, when an emergency situation occurs, an emergency call can be made between the smartphone user and the guardian terminal based on the transmission of emergency information. In this case, the guardian terminal should make a telephone call to a police officer from the organization server after blocking a communication line connected to the smartphone user in order to make a telephone call requesting the police officer from the organization server to rescue the smartphone user. Accordingly, a disadvantage arises in that an emergency situation of the smartphone user cannot be continuously monitored.

### DISCLOSURE

### Technical Problem

Accordingly, the present invention has been made keeping in mind the above problems occurring in the prior art, and an object of the present invention is to enable an organization, such as a police department or a fire department, to deal with an emergency situation within a short period of time when the emergency situation of a smartphone user occurs in such a manner that, when emergency information is transmitted to a preset guardian terminal through the pressing of a plurality of emergency buttons, the guardian terminal authenticates the emergency situation and transmits information about the emergency situation of the smartphone user to an organization server and then a police officer from the organization server is dispatched to the location coordinates of the smartphone user received from a mobile communication service provider.

Furthermore, an object of the present invention is to prevent secondary damage attributable to the Internet banking account transfer of a smartphone user in such a manner as to, when an emergency situation occurs and a smartphone user transmits emergency information to a preset guardian terminal through the pressing of a plurality of emergency buttons, convert the Internet banking account of the smartphone user to a preset virtual Internet banking account and then provide a virtual Internet banking service.

Furthermore, an object of the present invention is to prevent secondary damage attributable to the withdrawal of cash of a smartphone user in such a manner as to, when an emergency situation occurs and the smartphone user transmits emergency information to a preset guardian terminal through the pressing of a plurality of emergency buttons, convert a bank account linked to a smartphone identification number and a corresponding debit card or check card to a preset virtual bank account and then provide an offline banking service.

Moreover, an object of the present invention is to prevent secondary damage attributable to the credit card payment and card loan of a smartphone user in such a manner as to, when an emergency situation occurs and the smartphone user transmits emergency information to a preset guardian terminal through the pressing of a plurality of emergency buttons, register the credit card information of the smartphone user as the information of a lost card.

### Technical Solution

In order to accomplish the above objects, the present invention provides a system for preventing the abuse of an emergency call using a smartphone, including a smartphone (100) configured to transmit emergency rescue request information and financial service stop request information, generated by pressing of a plurality of emergency buttons, to a mobile communication service provider server (200), and to, when an Internet banking application is executed, perform control in order to convert an Internet banking connection URL into a preset virtual connection URL and then allow an Internet banking service to be conducted in a virtual Internet banking URL page; the mobile communication service provider server (200) configured to receive emergency rescue request information and financial service stop request information from the smartphone (100) and then transmit a generated authentication number, together with the financial service stop request information, to a guardian terminal (300), to receive an authentication response number from the guardian terminal (300) and transmit location coordinates of the smartphone, received through a connection to a GPS satellite, and the emergency rescue request information to an organization server (400), and to control a telephone call connection between the smartphone (100) and the guardian terminal (300) in response to a call connection request signal received from the guardian terminal (300); the guardian terminal (300) configured to receive the emergency rescue request information, the financial service stop request information and the authentication number from the mobile communication service provider server (200) and then transmit the authentication response number, received through manipulation of a guardian, to the mobile communication service provider server (200), to transmit the emergency rescue request information and the financial service stop request information to the organization server (400), and to transmit a call connection request signal for a three-party conference call with the smartphone (100) and the organization server (400) to the mobile communication service provider server (200); and the organization server (400) configured to receive the location coordinates of the smartphone and the emergency rescue request information from the mobile communication service provider server (200), to transmit dispatch information generated for a purpose of rescuing a smartphone user to a police department or a fire department located within a radius around the location coordinates of the smartphone, to generate bank transaction stop information adapted to allow a financial service, related to the account number included in the financial service stop request information received from the guardian terminal (300), to be conducted via a virtual account and then transmit the bank transaction stop information, together with the emergency rescue request information, to a bank server (500), and to generate credit card theft information related to the credit card identification number received from the guardian terminal 300 and then transmit the credit card theft information to a credit card company server (600).

Furthermore, there is provided a method of preventing abuse of an emergency call using a smartphone based on the above-described system, including (a) transmitting, by a smartphone (100), emergency rescue request information and financial service stop request information, received through pressing of a plurality of emergency buttons, to a mobile communication service provider server (200); (b) receiving, by the mobile communication service provider server (200), the emergency rescue request information and transmitting, by the mobile communication service provider server (200), a generated authentication number and financial service stop request information to a guardian terminal (300) included in the emergency rescue request information; (c) when an authentication response number received from the guardian terminal (300) corresponds to the authentication number, transmitting, by the mobile communication service provider server (200), location coordinates of the smartphone connected to a GPS satellite and the emergency rescue request information to an organization server (400); (d) transmitting, by the organization server (400), dispatch information to a police department or a fire department located within a radius around the location coordinates of the smartphone; (e) transmitting, by the guardian terminal (300), the financial service stop request information, received from the mobile communication service provider server (200), to the organization server (400); (f) generating, by the organization server (400), bank transaction stop information corresponding to the financial service stop request information received from the guardian terminal (300) and then transmitting, by the organization server (400), the bank transaction stop information, together with the emergency rescue request information, to a bank server (500), and generating, by the organization server (400), credit card theft information related to the a credit card identification number received from the guardian terminal 300 and then transmitting, by the organization server (400), the credit card theft information to the credit card company server (600); (g) when detecting a banking service corresponding to a smartphone identification number included in the emergency rescue request information, determining, by the bank server (500), whether the detected banking service is an offline banking service or an online banking service; (h) if, as a result of the determination at step (g), it is determined that the bank server (500) has detected use of an offline banking service, performing control in order to convert a bank account corresponding to the smartphone identification number into a preset virtual bank account and then allow the offline banking service to be conducted; (i) receiving, by a credit card company server (600), credit card theft information from the organization server (400), and registering, by the credit card company server (600), a credit card identification number included in the credit card theft information as information of the stolen card; and (j) when receiving credit card payment request information corresponding to the credit card identification number from a POS terminal or an Internet shopping mall server, transmitting, by the credit card company server (600) stolen card payment prohibition information to the POS terminal or the Internet shopping mall server.

### Advantageous Effects

In accordance with the present invention, there is achieved the advantage of enabling an organization, such as a police department or a fire department, to deal with an emergency situation within a short period of time when the emergency situation of a smartphone user occurs in such a manner that, when emergency information is transmitted to a preset guardian terminal through the pressing of a plurality of emergency buttons, the guardian terminal authenticates the emergency situation and transmits information about the emergency situation of the smartphone user to an organization server and then a police officer from the organization server is dispatched to the location coordinates of the smartphone user received from a mobile communication service provider.

Furthermore, in accordance with the present invention, there is achieved the advantage of preventing secondary damage attributable to the Internet banking account transfer of a smartphone user in such a manner as to, when an emergency situation occurs and the smartphone user transmits emergency information to a preset guardian terminal through the pressing of a plurality of emergency buttons, convert the Internet banking account of a smartphone user to a preset virtual Internet banking account and then provide a virtual Internet banking service.

Furthermore, in accordance with the present invention, there is achieved the advantage of preventing secondary damage attributable to the withdrawal of cash of a smartphone user in such a manner as to, when an emergency situation occurs and the smartphone user transmits emergency information to a preset guardian terminal through the pressing of a plurality of emergency buttons, convert a bank account linked to a smartphone identification number and a corresponding debit card or check card to a preset virtual bank account and then provide an offline banking service.

Moreover, in accordance with the present invention, there is achieved the advantage of preventing secondary damage attributable to the credit card payment and card loan of a smartphone user in such a manner as to, when an emergency situation occurs and the smartphone user transmits emergency information to a preset guardian terminal through the pressing of a plurality of emergency buttons, register the credit card information of the smartphone user as the information of a lost card.

### DESCRIPTION OF DRAWINGS

FIG. 1 is a configuration diagram illustrating a conventional system and method for preventing the abuse of an emergency call using a smartphone;

FIG. 2 is a configuration diagram illustrating a system for preventing the abuse of an emergency call using a smartphone according to the present invention;

FIG. 3 is a configuration diagram illustrating the smartphone of the system for preventing the abuse of an emergency call using a smartphone according to the present invention;

FIG. 4 is a configuration diagram illustrating the mobile communication service provider server of the system for preventing the abuse of an emergency call using a smartphone according to the present invention;

FIG. 5 is a configuration diagram illustrating the guardian terminal of the system for preventing the abuse of an emergency call using a smartphone according to the present invention;

FIG. 6 is a configuration diagram illustrating the organization server of the system for preventing the abuse of an emergency call using a smartphone according to the present invention;

FIG. 7 is a configuration diagram illustrating the bank server of the system for preventing the abuse of an emergency call using a smartphone according to the present invention;

FIG. 8 is a configuration diagram illustrating the credit card company server of the system for preventing the abuse of an emergency call using a smartphone according to the present invention;

FIG. 9 is a flowchart illustrating a method of preventing the abuse of an emergency call using a smartphone according to the present invention;

FIG. 10 is a flowchart illustrating step S110 of the method of preventing the abuse of an emergency call using a smartphone according to the present invention;

FIG. 11 is a flowchart illustrating the detailed process of step S30 of the method of preventing the abuse of an emergency call using a smartphone according to the present invention; and

FIG. 12 is a flowchart illustrating the process that is performed after step S50 of the method of preventing the abuse of an emergency call using a smartphone according to the present invention.

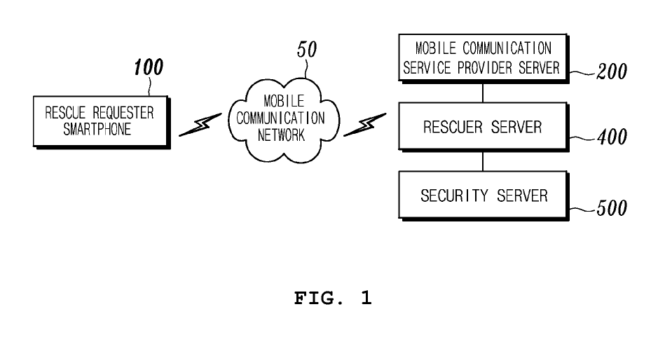

[Description of Reference Characters]

| S: | system for preventing the abuse of an |
|---|---|
| | emergency call using a smartphone |
| 100: | smartphone |
| 110: | emergency call detection module |
| 120: | application control module |
| 130: | call connection module |
| 200: | mobile communication service provider server |
| 210: | authentication number generation module |
| 220: | authentication number matching module |
| 230: | GPS satellite connection module |
| 240: | telephone call relay module |
| 300: | guardian terminal |
| 310: | emergency information checking module |
| 320: | emergency information transmission module |
| 330: | emergency call connection module |
| 400: | organization server |
| 500: | bank server |
| 510: | banking service detection module |
| 520: | offline banking conversion module |
| 530: | online banking conversion module |
| 600: | credit card company server |

### BEST MODE

The specific features and advantages of the present invention will be more apparent from the following detailed description based on the accompanying drawings. Prior to the following description, it is noted that the terms and words used in the present specification and claims should be interpreted as having meanings and concepts appropriate for the technical concept of the present invention based on the principle that an inventor can appropriately define the concepts of terms so as to describe his or her invention in the best way. Furthermore, it should be noted that if detailed descriptions of well-known functions and configurations related to the present invention are deemed to make the gist of the present invention unnecessarily obscure, they are omitted below.

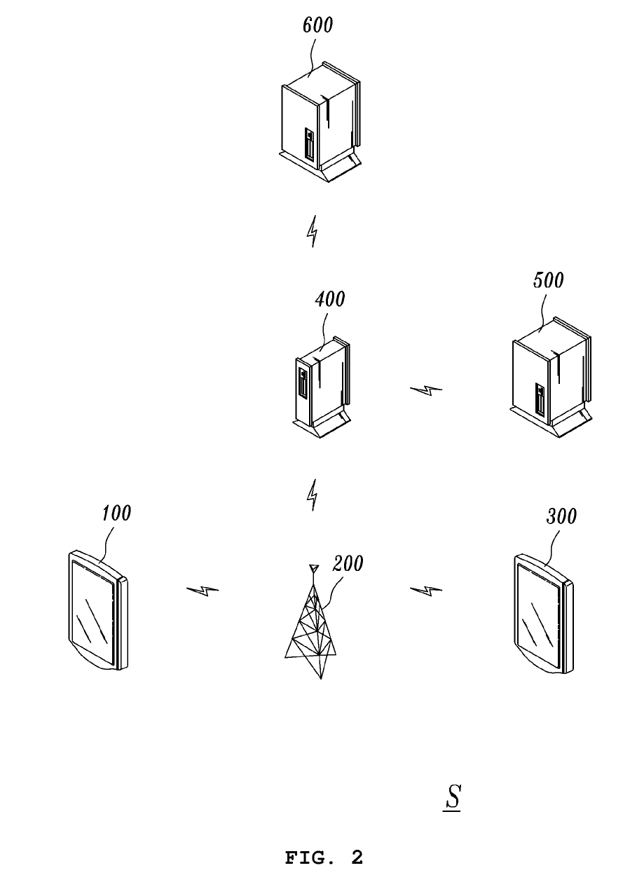

As illustrated in FIG. 2, a system S for preventing the abuse of an emergency call using a smartphone according to the present invention includes a smartphone 100, a mobile communication service provider server 200, a guardian terminal 300, an organization server 400, a bank server 500, and a credit card company server 600.

Although a description thereof will not be made below, it is desired that the transmission and reception of information among the smartphone 100, the mobile communication service provider server 200, the guardian terminal 300, the organization server 400 and the bank server 500 according to the present invention is understood as being performed over an information and communication network, and it is desired that the information and communication network is understood as collectively referring to wireless networks that are capable of the transmission and reception of data using any one communication method of wireless Internet (3G network/4G network) communication or Wireless Fidelity (WiFi) communication.

First, the smartphone 100 transmits emergency rescue request information and financial service stop request information, generated by the pressing of a plurality of emergency buttons, to the mobile communication service provider server 200. When an Internet banking application is executed, the smartphone 100 performs control in order to convert an Internet banking connection URL into a preset virtual connection URL and then allow an Internet banking service to be conducted in a virtual Internet banking URL page. The smartphone 100 is configured to include an emergency call detection module 110, an application control module 120, and a call connection module 130.

In this case, it is desired that the smartphone 100 according to the present invention is understood as a communication device including an Internet phone or a tablet PC capable of placing a telephone call and establishing an Internet connection.

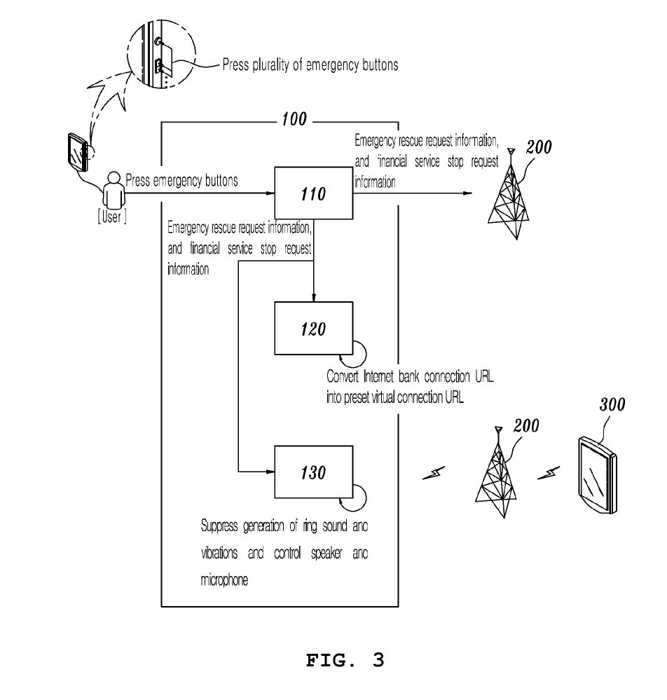

More specifically, an emergency call service using smartphone authentication and the smartphone 100 of an online/offline banking security system S according to the present invention will be described with reference to FIG. 3 below.

The emergency call detection module 110 of the smartphone 100 transmits emergency rescue request information, generated by detecting a signal received through the pressing of a plurality of emergency buttons and including a smartphone identification number and a preset guardian terminal identification number in the information, and financial service stop request information, adapted to include an account number and a credit card identification number previously stored in storage, to the mobile communication service provider server 200 connected over an information and communication network.

In this case, although the emergency call detection module 110 is configured to, when the pressing of a volume button and a power button provided on the smartphone has continued for a preset time, determine that an emergency situation has occurred, and to generate emergency rescue request information and financial service stop request information, the present invention is not limited thereto, and the above-described operation is not dependent on the pressing of specific buttons. That is, it is desired that emergency rescue request information and financial service stop request information is understood as being generated when the pressing of a plurality of buttons has continued for a preset time.

Furthermore, when a previously installed Internet banking application is executed after the emergency rescue request information has been received from the emergency call detection module 110, the application control module 120 performs control in order to convert an Internet banking connection URL into a preset virtual connection URL and then conduct an Internet banking service in a virtual Internet banking URL page.

After receiving the emergency rescue request information from the emergency call detection module 110, the call connection module 130 detects a call connection request signal received from the mobile communication service provider server 200 and then connects a telephone call to the guardian terminal 300.

Furthermore, the call connection module 130 performs control so that ring sound output or vibrations are prevented from being generated when detecting a call connection request signal, and controls a contained speaker and microphone so that a telephone call is connected to the guardian terminal 300 without requiring separate key input for call connection at the same time that the call connection request signal is detected.

In this case, the call connection module 130 performs control in order to suppress voice output from the guardian terminal 300 via the speaker and to transmit voices input to the microphone to the guardian terminal 300 with which the call connection has been established.

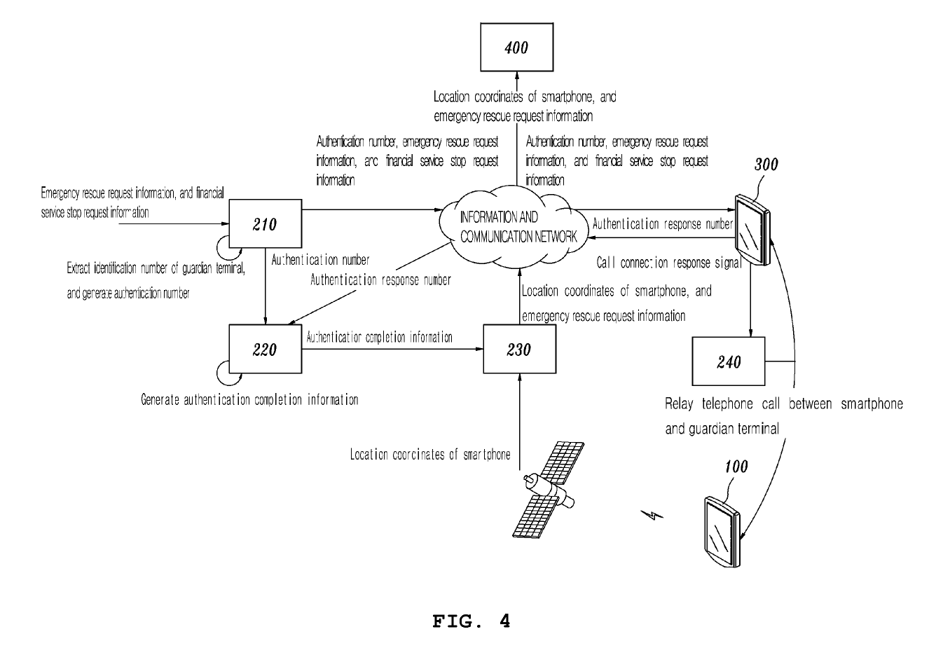

Meanwhile, the mobile communication service provider server 200 of the system S for preventing the abuse of an emergency call using a smartphone according to the present invention is described with reference to FIG. 4 below.

The mobile communication service provider server 200 receives emergency rescue request information and financial service stop request information from the smartphone 100 connected over the information and communication network and then transmits a generated authentication number, together with the financial service stop request information, to the guardian terminal 300, receives an authentication response number from the guardian terminal 300 and transmits the location coordinates of the smartphone, received through the connection to a GPS satellite, and the emergency rescue request information to the organization server 400, and controls a telephone call connection between the smartphone 100 and the guardian terminal 300 in response to a call connection request signal received from the guardian terminal 300. The mobile communication service provider server 200 is configured to include an authentication number generation module 210, an authentication number matching module 220, a GPS satellite connection module 230, and a telephone call relay module 240.

More specifically, the authentication number generation module 210 of the mobile communication service provider server 200 extracts the guardian terminal identification number from the emergency rescue request information received from the smartphone 100 connected over the information and communication network, converts an authentication number randomly generated by a random number generator into an SMS message form, and transmits the authentication number, together with the emergency rescue request information and the financial service stop request information, to the guardian terminal 300.

Furthermore, the authentication number matching module 220 generates authentication completion information when the authentication response number received from the guardian terminal 300 corresponds to the authentication number received from the authentication number generation module 210.

Furthermore, the GPS satellite connection module 230 receives the authentication completion information from the authentication number matching module 220, and transmits the location coordinates of the smartphone connected to the GPS satellite and the emergency rescue request information to the organization server 400.

Moreover, when receiving a call connection request signal for connecting with the smartphone 100 from the guardian terminal 300, the telephone call relay module 240 relays a telephone call between the smartphone 100 and the guardian terminal 300.

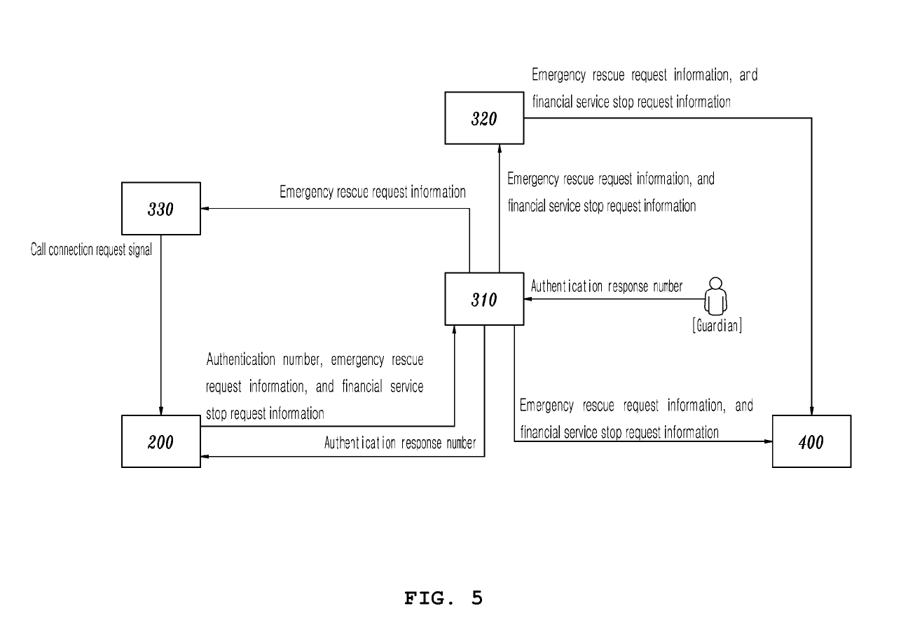

Meanwhile, the guardian terminal 300 of the system S for preventing the abuse of an emergency call using a smartphone according to the present invention is described with reference to FIG. 5 below.

The guardian terminal 300 receives the emergency rescue request information, the financial service stop request information and the authentication number from the mobile communication service provider server 200 and then transmits the authentication response number, received through the manipulation of a guardian, to the mobile communication service provider server 200, transmits the emergency rescue request information and the financial service stop request information to the organization server 400, and transmits a call connection request signal for a three-party conference call with the smartphone 100 and the organization server 400 to the mobile communication service provider server 200. The guardian terminal 300 is configured to include an emergency information checking module 310, an emergency information transmission module 320, and an emergency call connection module 330.

More specifically, the emergency information checking module 310 of the guardian terminal 300 receives the emergency rescue request information, the financial service stop request information and the authentication number from the mobile communication service provider server 200 connected over the information and communication network, and transmits the authentication response number, received through the manipulation of the guardian, to the mobile communication service provider server 200.

Furthermore, the emergency information transmission module 320 transmits the emergency rescue request information and the financial service stop request information, received from the emergency information checking module 310, to the organization server 400, connected over the information and communication network, in response to the execution of a previously installed emergency rescue application.

Furthermore, the emergency call connection module 330 transmits a call connection request signal for a three-party conference call with smartphone 100 and the organization server 400, corresponding to the emergency rescue request information received from the emergency information checking module 310, to the mobile communication service provider server 200, thereby controlling a telephone call with the smartphone 100 and the organization server 400.

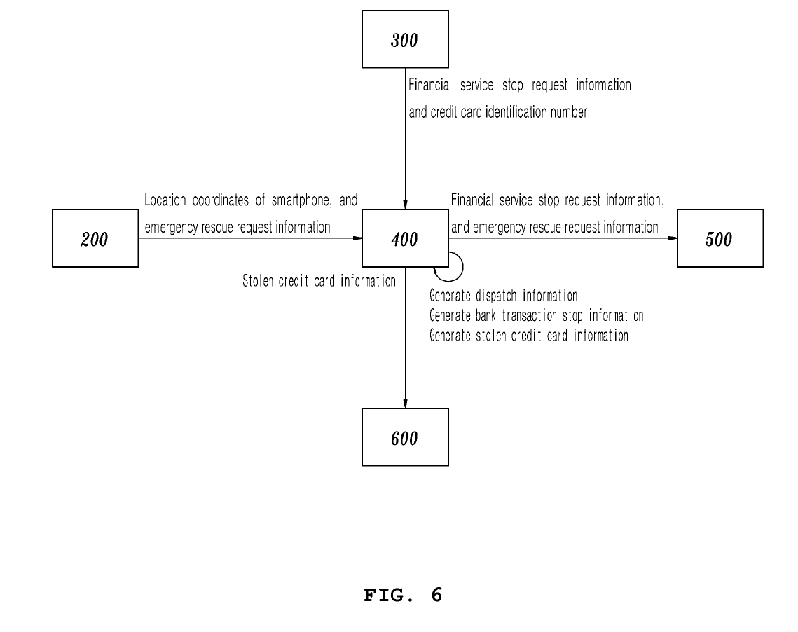

Meanwhile, the organization server 400 of the system S for preventing the abuse of an emergency call using a smartphone according to the present invention is described with reference to FIG. 6 below.

The organization server 400 receives the location coordinates of the smartphone and the emergency rescue request information from the mobile communication service provider server 200 connected over the information and communication network, transmits dispatch information generated for the purpose of rescuing a smartphone user to a police department or a fire department located within a radius around the location coordinates of the smartphone, generates bank transaction stop information adapted to allow a financial service, related to the account number included in the financial service stop request information received from the guardian terminal 300, to be conducted via a virtual account and then transmits the bank transaction stop information, together with the emergency rescue request information, to the bank server 500, and generates credit card theft information related to the credit card identification number received from the guardian terminal 300 and then transmits the credit card theft information to the credit card company server 600.

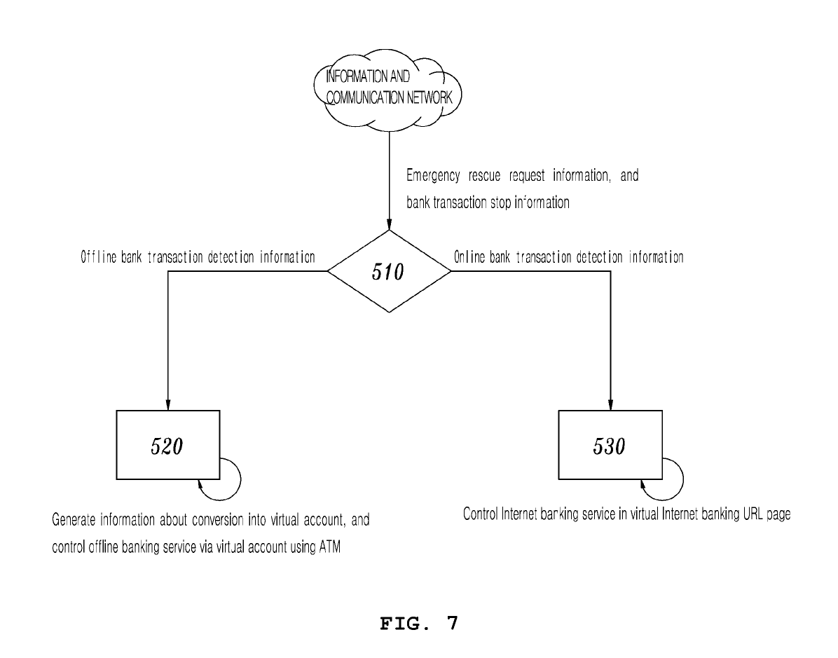

Furthermore, the bank server 500 of the system S for preventing the abuse of an emergency call using a smartphone according to the present invention is described with reference to FIG. 7 below.

The bank server 500 receives the emergency rescue request information and the bank transaction stop information from the organization server 400 connected over the information and communication network, and, when detecting the use of an offline banking service including any one of a debit card and a check card linked to a bank account corresponding to the smartphone identification number included in the emergency rescue request information, performs control in order to convert a bank account corresponding to the smartphone identification number into a preset virtual bank account and then conduct the offline banking service.

Furthermore, the bank server 500 receives the emergency rescue request information and the bank transaction stop information from the organization server 400 connected over the information and communication network, and, when detecting the use of an Internet banking service corresponding the smartphone identification number included in the emergency rescue request information, performs control so that the smartphone 100 converts an Internet banking connection URL into a preset virtual connection URL and then conducts the Internet banking service in a virtual Internet banking URL page.

More specifically, the banking service detection module 510 of the bank server 500 generates offline banking transaction detection information when receiving the emergency rescue request information and the bank transaction stop information from the organization server 400 and then receiving a connection signal of a debit card or a check card linked to a bank account corresponding to the smartphone identification number from an ATM provided in an bank, and generates online banking transaction detection information when detecting the use of an Internet banking service corresponding to the smartphone identification number over the information and communication network.

Furthermore, when receiving the offline banking transaction detection information from the banking service detection module 510, the offline banking conversion module 520 performs control in order to transmit conversion-into-virtual account information adapted to convert a bank account corresponding to the smartphone identification number into a preset virtual bank account to an ATM, so that the ATM conducts an offline banking service in a virtual account environment.

In this case, the virtual bank account is an account that has been previously generated in response to a request from the user of the smartphone 100. When the balance has been set to “0 won” upon the generation of the virtual bank account, cash is not withdrawn from the bank account corresponding to the smartphone identification number.

Furthermore, when receiving the online banking transaction detection information from the banking service detection module 510, the online banking conversion module 530 performs control in order to convert an Internet banking URL linked to the smartphone 100 into a preset virtual Internet banking URL, thereby allowing an Internet banking service to be conducted in a virtual Internet banking URL page.

In this case, the conversion into the virtual Internet banking URL performs control so that, when connecting to an Internet banking service over the wireless Internet in response to the execution of an Internet banking application of the smartphone 100, the smartphone 100 moves to a URL page having the same Internet banking environment as an original Internet banking service and then conducts an Internet banking service.

In this case, when the smartphone 100 conducts an account transfer task, control is performed such that a transfer-requested amount of money that belongs to a specific amount of money deposited in the account corresponding to the smartphone identification number is transferred to a desired target account. As the Internet banking service is conducted in the virtual account corresponding to the smartphone identification number, the transfer-requested amount of money is not actually transferred to the desired target account, but the transfer-requested amount of money is displayed on the screen of the smartphone 100 as being transferred to the desired target account.

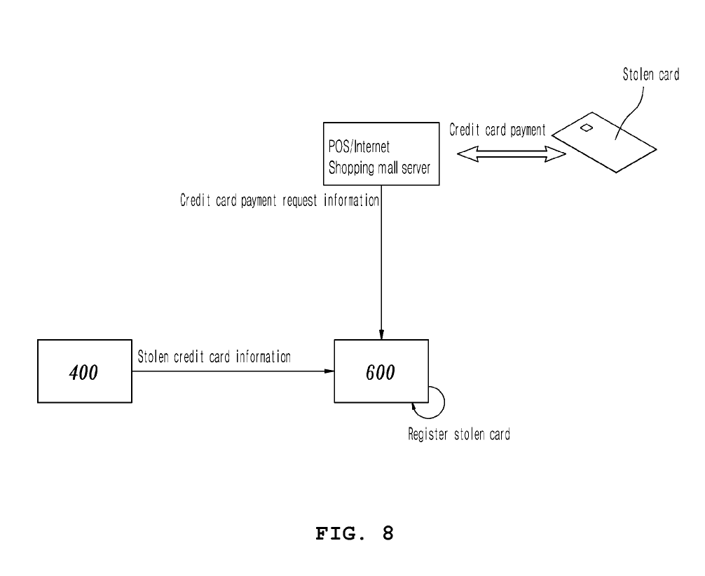

Furthermore, the credit card company server 600 of the system S for preventing the abuse of an emergency call using a smartphone according to the present invention is described with reference to FIG. 8 below.

The credit card company server 600 receives credit card theft information from the organization server 400 connected over the information and communication network, and registers a credit card identification number included in the credit card theft information as the information of a stolen card. Meanwhile, when receiving credit card payment request information corresponding to the credit card identification number from a POS terminal or an Internet shopping mall server, the credit card company server 600 transmits stolen card payment prohibition information to the POS terminal or the Internet shopping mall server.

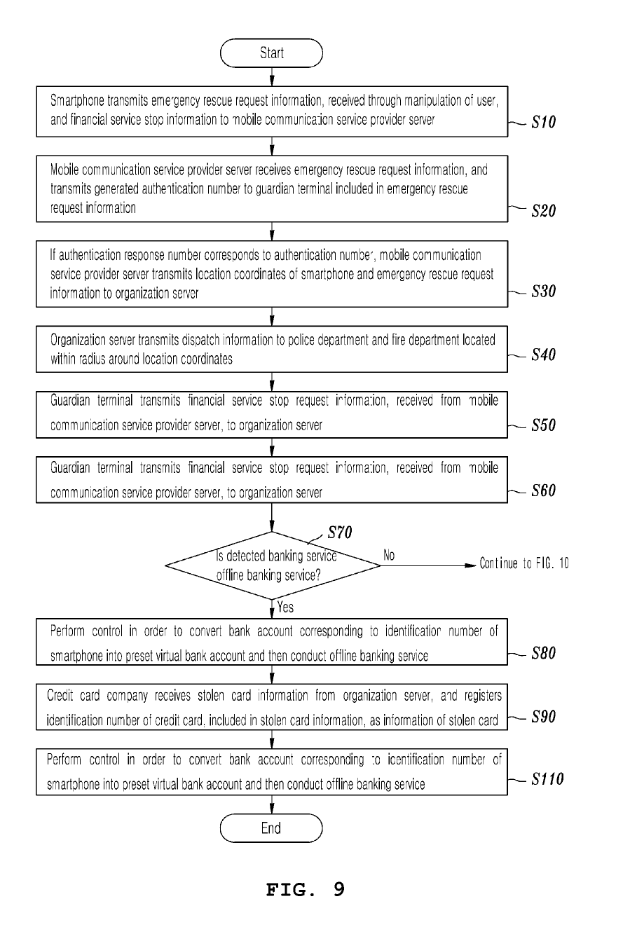

A method of preventing the abuse of an emergency call using a smartphone according to the present invention is described with reference to FIG. 9.

First, the smartphone 100 transmits emergency rescue request information and financial service stop request information, received through the pressing of a plurality of emergency buttons, to the mobile communication service provider server 200 at step S10.

Thereafter, the mobile communication service provider server 200 receives the emergency rescue request information and transmits a generated authentication number and financial service stop request information to the guardian terminal 300 included in the emergency rescue request information at step S20.

Thereafter, when an authentication response number received from the guardian terminal 300 corresponds to the authentication number, the mobile communication service provider server 200 transmits the location coordinates of the smartphone connected to a GPS satellite and the emergency rescue request information to the organization server 400 at step S30.

Thereafter, the organization server 400 transmits dispatch information to a police department or a fire department located within a radius around the location coordinates of the smartphone at step S40.

Thereafter, the guardian terminal 300 transmits the financial service stop request information, received from the mobile communication service provider server 200, to the organization server 400 at step S50.

Thereafter, the organization server 400 generates bank transaction stop information corresponding to the financial service stop request information received from the guardian terminal 300 and then transmits the bank transaction stop information, together with the emergency rescue request information, to the bank server 500, and generates credit card theft information related to the a credit card identification number received from the guardian terminal 300 and then transmits the credit card theft information to the credit card company server 600 at step S60.

Thereafter, when detecting a banking service corresponding to a smartphone identification number included in the emergency rescue request information, the bank server 500 determines whether the detected banking service is an offline banking service or an online banking service at step S70.

If, as a result of the determination at step S70, it is determined that the bank server 500 has detected the use of an offline banking service, control is performed in order to convert a bank account corresponding to the smartphone identification number into a preset virtual bank account and then allow the offline banking service to be conducted at step S80.

Thereafter, the credit card company server 600 receives credit card theft information from the organization server 400 and registers a credit card identification number included in the credit card theft information as the information of the stolen card at step S90.

Furthermore, when receiving credit card payment request information corresponding to the credit card identification number from a POS terminal or an Internet shopping mall server, the credit card company server 600 transmits stolen card payment prohibition information to the POS terminal or the Internet shopping mall server at step S100.

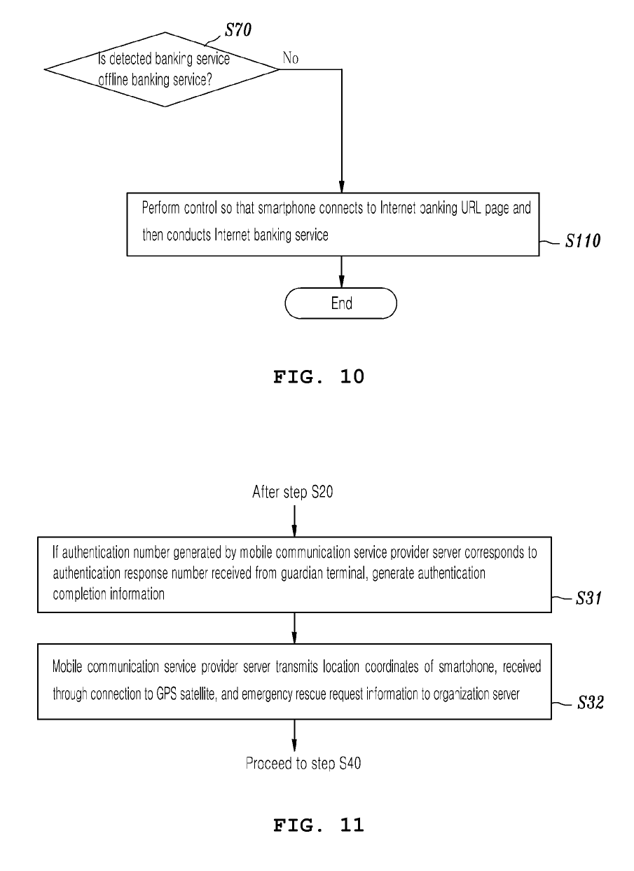

Meanwhile, as illustrated in FIG. 10, if, as a result of the determination at step S70, it is determined that the bank server 500 has detected the use of an online banking service, control is performed such that the smartphone 100 converts an Internet banking connection URL into a preset virtual connection URL and then conducts the Internet banking service in a virtual Internet banking URL page at step S110.

Meanwhile, the detailed process of step S30 of the method of preventing the abuse of an emergency call using a smartphone according to the present invention is described with reference to FIG. 11 below.

After step S20, when the generated authentication number corresponds to the authentication response number received from the guardian terminal 300, the mobile communication service provider server 200 generates authentication completion information at step S31.

Furthermore, at step S32, the mobile communication service provider server 200 transmits the location coordinates of the smartphone, received through the connection to a GPS satellite, and the emergency rescue request information to the organization server 400 in response to the generation of the authentication completion information, and the process proceeds to step S40.

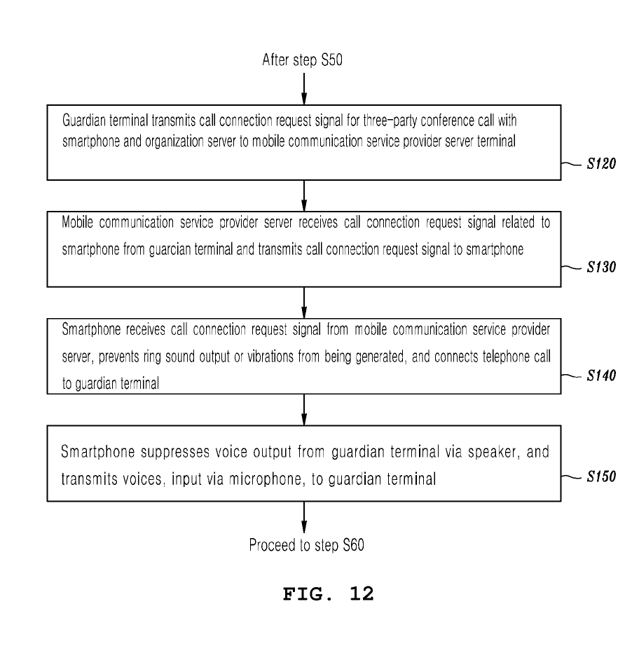

Furthermore, the process that is performed after step S50 of the method of preventing the abuse of an emergency call using a smartphone according to the present invention is described with reference to FIG. 12 below.

After step S50, the guardian terminal 300 transmits a call connection request signal for a three-party conference call with the smartphone 100 and the organization server 400 to the mobile communication service provider server 200 at step S120.

Thereafter, the mobile communication service provider server 200 receives the call connection request signal related to the smartphone 100 from the guardian terminal 300 and transmits the call connection request signal to the smartphone 100 at step S130.

Thereafter, the smartphone 100 receives the call connection request signal from the mobile communication service provider server 200, performs control in order to prevent ring sound output or vibrations from being generated, and connects a telephone call to the guardian terminal 300 at step S140.

Furthermore, at step S150, control is performed such that the smartphone 100 suppresses voice output from the guardian terminal 300, with which the call connection has been established, via a speaker, and transmits voices, input via a microphone, to the guardian terminal 300 with which the call connection has been established, and the process proceeds to step S60.

Although the present invention has been described and illustrated with reference to preferred embodiments illustrative of the technical spirit of the present invention, the present invention is not limited to the described and illustrated configurations and operations without changes. It will be apparent to those skilled in the art that a plurality of variations and modifications may be made to the present invention without departing from the scope of the technical spirit of the present invention. Accordingly, all such appropriate variations and modifications and the equivalents thereof should be considered to fall within the scope of the present invention.

1. A system for preventing abuse of an emergency call using a smartphone, comprising:
a smartphone configured to transmit emergency rescue request information and financial service stop request information, generated by pressing of an emergency button, to a mobile communication service provider server, and to, when an Internet banking application is executed, perform control in order to convert an Internet banking connection URL into a preset virtual connection URL and then allow an Internet banking service to be conducted in a virtual Internet banking URL page;
the mobile communication service provider server configured to receive emergency rescue request information and financial service stop request information from the smartphone and then transmit a generated authentication number, together with the financial service stop request information, to a guardian terminal, to receive an authentication response number from the guardian terminal and transmit location coordinates of the smartphone, received through a connection to a GPS satellite, and the emergency rescue request information to an organization server, and to control a telephone call connection between the smartphone and the guardian terminal in response to a call connection request signal received from the guardian terminal;
the guardian terminal configured to receive the emergency rescue request information, the financial service stop request information and the authentication number from the mobile communication service provider server and then transmit the authentication response number, received through manipulation of a guardian, to the mobile communication service provider server, to transmit the emergency rescue request information and the financial service stop request information to the organization server, and to transmit a call connection request signal for a three-party conference call with the smartphone and the organization server to the mobile communication service provider server; and
the organization server configured to receive the location coordinates of the smartphone and the emergency rescue request information from the mobile communication service provider server, to transmit dispatch information generated for a purpose of rescuing a smartphone user to a police department or a fire department located within a radius around the location coordinates of the smartphone, to generate bank transaction stop information adapted to allow a financial service, related to the account number included in the financial service stop request information received from the guardian terminal, to be conducted via a virtual account and then transmit the bank transaction stop information, together with the emergency rescue request information, to a bank server, and to generate credit card theft information related to the credit card identification number received from the guardian terminal and then transmit the credit card theft information to a credit card company server.

2. The system of claim 1, further comprising:
the bank server configured to receive the emergency rescue request information and the bank transaction stop information from the organization server, to, when detecting use of an offline banking service including any one of a debit card and a check card linked to a bank account corresponding to the smartphone identification number included in the emergency rescue request information, perform control in order to convert a bank account corresponding to the smartphone identification number into a preset virtual bank account and then conduct the offline banking service, to receive the emergency rescue request information and the bank transaction stop information from the organization server, and to, when detecting the of an Internet banking service corresponding the smartphone identification number included in the emergency rescue request information, perform control so that the smartphone converts an Internet banking connection URL into a preset virtual connection URL and then conducts the Internet banking service in a virtual Internet banking URL page; and
the credit card company server configured to receive credit card theft information from the organization server and register a credit card identification number included in the credit card theft information as the information of a stolen card, and to, when receiving credit card payment request information corresponding to the credit card identification number from a POS terminal or an Internet shopping mall server, transmit stolen card payment prohibition information to the POS terminal or the Internet shopping mall server.

3. The system of claim 1, wherein the smartphone comprises:
an emergency call detection module configured to transmit emergency rescue request information, generated by detecting a signal received through the pressing of a plurality of emergency buttons and including a smartphone identification number and a preset guardian terminal identification number in the information, and financial service stop request information, adapted to include an account number and a credit card identification number previously stored in storage, to the mobile communication service provider server (200) connected over an information and communication network;
an application control module configured to, when a previously installed Internet banking application is executed after the emergency rescue request information has been received from the emergency call detection module, perform control in order to convert an Internet banking connection URL into a preset virtual connection URL and then conduct an Internet banking service in a virtual Internet banking URL page;
a call connection module configured to, after receiving the emergency rescue request information from the emergency call detection module, detect a call connection request signal received from the mobile communication service provider server and then connect a telephone call to the guardian terminal, the call connection module performing control so that ring sound output or vibrations are prevented from being generated when detecting a call connection request signal, the call connection module controlling a contained speaker and microphone so that a telephone call is connected to the guardian terminal without requiring separate key input for call connection at the same time that the call connection request signal is detected, and the call connection module performing control in order to suppress voice output from the guardian terminal via the speaker and to transmit voices input to the microphone to the guardian terminal with which the call connection has been established.

4. The system of claim 1, wherein the mobile communication service provider server comprises:
an authentication number generation module configured to extract the guardian terminal identification number from the emergency rescue request information received from the smartphone, to convert an authentication number randomly generated by a random number generator into an SMS message form, and to transmit the authentication number, together with the emergency rescue request information and the financial service stop request information, to the guardian terminal;
an authentication number matching module configured to generate authentication completion information when the authentication response number received from the guardian terminal corresponds to the authentication number received from the authentication number generation module;
a GPS satellite connection module configured to receive the authentication completion information from the authentication number matching module, and to transmit the location coordinates of the smartphone connected to the GPS satellite and the emergency rescue request information to the organization server; and
a telephone call relay module configured to, when receiving a call connection request signal for connecting with the smartphone from the guardian terminal, relay a telephone call between the smartphone and the guardian terminal.

5. The system of claim 1, wherein the guardian terminal comprises:
an emergency information checking module configured to receive the emergency rescue request information, the financial service stop request information and the authentication number from the mobile communication service provider server, and to transmit the authentication response number, received through manipulation of the guardian, to the mobile communication service provider server;
an emergency information transmission module configured to transmit the emergency rescue request information and the financial service stop request information, received from the emergency information checking module, to the organization server, connected over the information and communication network, in response to execution of a previously installed emergency rescue application; and
an emergency call connection module configured to transmit a call connection request signal for a three-party conference call with smartphone and the organization server, corresponding to the emergency rescue request information received from the emergency information checking module, to the mobile communication service provider server, thereby controlling a telephone call with the smartphone and the organization server.

6. The system of claim 2, wherein the bank server comprises:
a banking service detection module configured to generate offline banking transaction detection information when receiving the emergency rescue request information and the bank transaction stop information from the organization server and then receiving a connection signal of a debit card or a check card linked to a bank account corresponding to the smartphone identification number from an ATM provided in an bank, and to generate online banking transaction detection information when detecting use of an Internet banking service corresponding to the smartphone identification number over the information and communication network;
an offline banking conversion module configured to, when receiving the offline banking transaction detection information from the banking service detection module, perform control in order to transmit conversion-into-virtual account information adapted to convert a bank account corresponding to the smartphone identification number into a preset virtual bank account to an ATM, so that the ATM conducts an offline banking service in a virtual account environment; and
an online banking conversion module configured to, when receiving the online banking transaction detection information from the banking service detection module, perform control in order to convert an Internet banking URL linked to the smartphone into a preset virtual Internet banking URL, thereby allowing an Internet banking service to be conducted in a virtual Internet banking URL page.

7. The system of claim 6, wherein:
the conversion into the virtual Internet banking URL performs control so that, when connecting to an Internet banking service over a wireless Internet based on the execution of an Internet banking application of the smartphone, the smartphone moves to a URL page having an Internet banking environment identical to that of an original Internet banking service and then conducts an Internet banking service; and
when the smartphone conducts an account transfer service, control is performed such that a transfer-requested amount of money that belongs to a specific amount of money deposited in the account corresponding to the smartphone identification number is transferred to a desired target account, in which case, as the Internet banking service is conducted in the virtual account corresponding to the smartphone identification number, the transfer-requested amount of money is not actually transferred to the desired target account, but the transfer-requested amount of money is displayed on the screen of the smartphone as being transferred to the desired target account.

8. A method of preventing abuse of an emergency call using a smartphone, comprising:
(a) transmitting, by a smartphone, emergency rescue request information and financial service stop request information, received through pressing of an emergency button, to a mobile communication service provider server;
(b) receiving, by the mobile communication service provider server, the emergency rescue request information and transmitting, by the mobile communication service provider server, a generated authentication number and financial service stop request information to a guardian terminal included in the emergency rescue request information;
(c) when an authentication response number received from the guardian terminal corresponds to the authentication number, transmitting, by the mobile communication service provider server, location coordinates of the smartphone connected to a GPS satellite and the emergency rescue request information to an organization server;
(d) transmitting, by the organization server, dispatch information to a police department or a fire department located within a radius around the location coordinates of the smartphone;
(e) transmitting, by the guardian terminal, the financial service stop request information, received from the mobile communication service provider server, to the organization server;
(f) generating, by the organization server, bank transaction stop information corresponding to the financial service stop request information received from the guardian terminal and then transmitting, by the organization server, the bank transaction stop information, together with the emergency rescue request information, to a bank server, and generating, by the organization server, credit card theft information related to the a credit card identification number received from the guardian terminal and then transmitting, by the organization server, the credit card theft information to the credit card company server;
(g) when detecting a banking service corresponding to a smartphone identification number included in the emergency rescue request information, determining, by the bank server, whether the detected banking service is an offline banking service or an online banking service;
(h) if, as a result of the determination at step (g), it is determined that the bank server has detected use of an offline banking service, performing control in order to convert a bank account corresponding to the smartphone identification number into a preset virtual bank account and then allow the offline banking service to be conducted;
(i) receiving, by a credit card company server, credit card theft information from the organization server, and registering, by the credit card company server, a credit card identification number included in the credit card theft information as information of the stolen card; and
(j) when receiving credit card payment request information corresponding to the credit card identification number from a POS terminal or an Internet shopping mall server, transmitting, by the credit card company server stolen card payment prohibition information to the POS terminal or the Internet shopping mall server.

9. The method of claim 8, further comprising, if, as a result of the determination at step (g), it is determined that the bank server has detected use of an online banking service, performing control such that the smartphone converts an Internet banking connection URL into a preset virtual connection URL and conducts the Internet banking service in a virtual Internet banking URL page.

10. The method of claim 8, wherein pressing is performed for a plurality of emergency buttons in step (a), and step (c) comprises:
(c-1) when the generated authentication number corresponds to the authentication response number received from the guardian terminal, generating, by the mobile communication service provider server, authentication completion information; and
(c-2) transmitting, by the mobile communication service provider server, the location coordinates of the smartphone, received through connection to a GPS satellite, and the emergency rescue request information to the organization server in response to the generation of the authentication completion information.

11. The method of claim 8, further comprising, after step (e):
(l) transmitting, by the guardian terminal, a call connection request signal for a three-party conference call with the smartphone and the organization server to the mobile communication service provider server;
(m) receiving, by the mobile communication service provider server, the call connection request signal related to the smartphone from the guardian terminal, and then transmitting, by the mobile communication service provider server, the call connection request signal to the smartphone;
(n) receiving, by the smartphone, the call connection request signal from the mobile communication service provider server, performing, by the smartphone, control in order to prevent ring sound output or vibrations from being generated, and connecting, by the smartphone, a telephone call to the guardian terminal; and
(o) performing control such that the smartphone suppresses voice output from the guardian terminal, with which the call connection has been established, via a speaker and transmits voices input via a microphone to the guardian terminal with which the call connection has been established, and proceeding to step (f).
